(19) United States
(12) Patent Application Publication
(10) Pub. No.: US 2019/0155834 A1
(43) Pub. Date: May 23, 2019

(54) Loading Method and Apparatus

(71) Applicant: Huawei Technologies Co., Ltd., Shenzhen (CN)

(72) Inventors: Yan Zhou, Shanghai (CN); Lan Zou, Shanghai (CN)

(21) Appl. No.: 16/251,971

(22) Filed: Jan. 18, 2019

Related U.S. Application Data
(63) Continuation of application No. PCT/CN2016/091089, filed on Jul. 22, 2016.

(51) Int. Cl. G06F 16/53; G06F 16/16; G06F 16/182; G06F 9/445; G06F 9/455

(52) U.S. Cl. CPC G06F 16/53; G06F 16/162; G06F 16/183; G06F 2009/45583; G06F 9/45558; G06F 2009/45595; G06F 9/445

(57) ABSTRACT

A method includes: receiving, by an NFVO device, a first loading request message from an NM unit, where the first loading request message includes image files of some virtualized network function modules in a VNF unit, and the first loading request message is used for requesting the NFVO device to load the image files; and loading, by the NFVO device, the image files.

### CROSS-REFERENCE TO RELATED APPLICATIONS

This application is a continuation of International Application No. PCT/CN2016/091089, filed on Jul. 22, 2016, the disclosure of which is hereby incorporated by reference in its entirety.

### TECHNICAL FIELD

The present invention relates to the field of communications technologies, and in particular, to a loading method and apparatus.

### BACKGROUND

Currently, communications services develop gloriously, and virtualization of communications networks increases a development speed of the communications services. Compared with conventional communications services, operators have to confront with a dynamically changing market and new differentiated requirements. In this context, a network functions virtualization (NFV) technology has been proposed. The NFV technology is a technology for running network functions on a universal physical device.

In an NFV environment, a conventional physical network element is mapped into a virtualized network function (VNF) unit. Currently, an operation performed on a VNF unit corresponds to an operation performed on an entire VNF package. When some operations are performed on only a sub-part in the VNF unit, the entire VNF package is also loaded. This causes other sub-parts in the VNF unit to be repeatedly loaded when no operation is required, causing resource waste.

### SUMMARY

Embodiments of the present invention provide a loading method and apparatus, to prevent sub-parts in a VNF unit that require no operation from being repeatedly loaded.

According to one aspect, an embodiment of the present invention provides a loading method. The method includes: receiving, by an NFVO unit, a first loading request message from an NM unit. The first loading request message includes image files of some virtualized network function modules in a virtualized network function VNF unit, and the first loading request message is used for requesting the NFVO unit to load the image files. The method further includes loading, by the NFVO unit, the image files. Optionally, the NFVO unit may further send a first loading response message to the NM unit, and the first loading response message is used for notifying that the image files are successfully loaded.

According to the solution provided in this embodiment of the present invention, when needing to load the image files of the some virtualized network function modules in the VNF unit, the NFVO unit may perform an independent loading operation on the image files rather than perform a loading operation on an entire VNF package as in a conventional processing method, thereby preventing image files of other virtualized network function modules in the VNF unit from being reloaded when the image files of only the some virtualized network function modules in the VNF unit need to be loaded.

In a possible design, the first loading request message may further include descriptors of the some virtualized network function modules. The descriptors are used for describing deployment information and maintenance information of the some virtualized network function modules, and the loading method may further include: loading, by the NFVO unit, the descriptors.

In this possible design, some virtualized network function modules in the VNF unit correspond to a package, including image files and descriptors of the some virtualized network function modules. When needing to load the image files and/or the descriptors of the some virtualized network function modules in the VNF unit, the NFVO may perform an independent loading operation on the package corresponding to the some virtualized network function modules rather than perform a loading operation on an entire VNF package as in a conventional processing method, thereby preventing image files or descriptors of other virtualized network function modules in the VNF unit from being reloaded when the image files and/or the descriptors of only the some virtualized network function modules need to be loaded.

In a possible design, the loading method may further include: receiving, by the NFVO unit, a second loading request message from the NM unit. The second loading request message includes descriptors of the some virtualized network function modules. The descriptors are used for describing deployment information and maintenance information of the some virtualized network function modules. The second loading request message is used for requesting the NFVO unit to load the descriptors. The loading method may further include loading, by the NFVO unit, the descriptors. Optionally, the NFVO unit may further send a second loading response message to the NM unit, and the second loading response message is used for notifying that the descriptors are successfully loaded.

According to this possible design, the NFVO unit may also perform an independent loading operation on the descriptors of the some virtualized network function modules, thereby preventing a deployment manner of other virtualized network function modules in the VNF unit from being repeatedly loaded when a deployment manner of only the some virtualized network function modules in the VNF unit needs to be updated.

In a possible design, the first loading request message or the second loading request message may further include identifiers of the descriptors, and the NFVO unit may load the descriptors and the identifiers of the descriptors.

In a possible design, the NFVO unit may further allocate identifiers of the descriptors to the descriptors; and the NFVO unit may load the descriptors and the identifiers of the descriptors. Optionally, the NFVO unit may further add the identifiers of the descriptors to the first loading response message to send the identifiers to the NM unit, or the NFVO unit may add the identifiers of the descriptors to another message to send the identifiers to the NM unit, so that the NM unit learns of the identifiers of the descriptors.

In a possible design, the loading method may further include: receiving, by the NFVO unit, a first management request message from the NM unit, where the first management request message is used for instructing the NFVO unit to update, query, or delete the image files; and updating, querying, or deleting, by the NFVO unit, the image files.

In this possible design, the NFVO unit can perform an independent management operation on the image files of the some virtualized network function modules in the VNF unit, to avoid reloading of image files of other virtualized network function modules in the VNF unit due to updating of an entire VNF package caused by updating or deletion of the image files of the some virtualized network function modules in a common processing method, thereby greatly reducing a workload of network maintenance.

In a possible design, the loading method may further include: receiving, by the NFVO unit, a second management request message from the NM unit, where the second management request message is used for instructing the NFVO unit to update, query, or delete the descriptors; and updating, querying, or deleting, by the NFVO unit, the descriptors.

In this possible design, the NFVO unit can perform an independent management operation on the descriptors of the some virtualized network function modules in the VNF unit, to avoid a problem of redeployment of the entire VNF unit caused by updating of a VNFD of the VNF unit in which the some virtualized network function modules are located because the some virtualized network function modules need to be redeployed or deleted in a common processing method, thereby greatly reducing a workload and a risk of network maintenance.

In a possible design, the loading method may further include: receiving, by the NFVO unit, a third management request message from the NM unit, where the third management request message is used for instructing the NFVO unit to update, query, or delete the image files and the descriptors; and updating, querying, or deleting, by the NFVO unit, the image files and the descriptors.

In this possible design, when a related management operation needs to be performed on the some virtualized network function modules in the VNF unit, for example, application software needs to be updated, a deployment manner needs to be updated, or the some virtualized network function modules need to be deleted, the NFVO unit performs an independent management operation on a package corresponding to the some virtualized network function modules, to avoid a related management operation performed on the entire VNF unit caused by a management operation performed on an entire VNF package because the related management operation needs to be performed on the some virtualized network function modules in a common processing method, thereby greatly reducing a workload and a risk of network maintenance.

In a possible design, the loading method may further include: sending, by the NFVO unit, an instantiation request message to a VNFM unit, where the instantiation request message includes identifiers of descriptors of all virtualized network function modules in the VNF unit, and the identifiers of the descriptors of all the virtualized network function modules are used for instantiation of the VNF unit.

In a possible design, the loading method may further include: sending, by the NFVO unit, a scale-out request message or a scale-in request message to the VNFM unit, where the scale-out request message or the scale-in request message includes the identifiers of the descriptors of the some virtualized network function modules, and the identifiers of the descriptors of the some virtualized network function modules are used for scale-out or scale-in of the some virtualized network function modules. It can be learned that based on this possible design, in a scale-out/scale-in process of the VNF unit, the NFVO unit may redeploy some designated virtualized network function modules in the VNF unit, and does not need to redeploy the entire VNF unit.

According to another aspect, an embodiment of the present invention provides another loading method. The method includes: sending, by an NM unit, a first loading request message to an NFVO unit. The first loading request message includes image files of some virtualized network function modules in a virtualized network function VNF unit, and the first loading request message is used for requesting the NFVO unit to load the image files. Optionally, the NM unit may further receive a first loading response message from the NFVO unit, and the first loading response message is used for notifying that the image files are successfully loaded.

According to the loading solution provided in this embodiment of the present invention, when the image files of the some virtualized network function modules in the VNF unit need to be loaded, the NM unit may instruct, by using the first loading request message, the NFVO unit to perform an independent loading operation on the image files rather than perform a loading operation on an entire VNF package as in a conventional processing method, thereby preventing image files of other virtualized network function modules in the VNF unit from being reloaded when the image files of only the some virtualized network function modules in the VNF unit need to be loaded.

In a possible design, the first loading request message may further include descriptors of the some virtualized network function modules, so that the NFVO unit loads the descriptors after receiving the first loading request message.

In a possible design, the loading method may further include: sending, by the NM unit, a second loading request message to the NFVO unit, where the second loading request message includes descriptors of the some virtualized network function modules, the descriptors are used for describing deployment information and maintenance information of the some virtualized network function modules, and the second loading request message is used for requesting the NFVO unit to load the descriptors. Optionally, the NM unit may further receive a second loading response message from the NFVO unit, and the second loading response message is used for notifying that the descriptors are successfully loaded.

In a possible design, the first loading request message or the second loading request message may further include identifiers of the descriptors, so that the NFVO unit loads the descriptors corresponding to the identifiers of the descriptors after receiving the first loading request message or the second loading request message.

In a possible design, the NM unit may further receive identifiers of the descriptors from the NFVO unit, and the identifiers of the descriptors are allocated by the NFVO.

In a possible design, the loading method may further include: sending, by the NM unit, a first management request message to the NFVO unit, where the first management request message is used for instructing the NFVO unit to update, query, or delete the image files.

In a possible design, the loading method may further include: sending, by the NM unit, a second management request message to the NFVO unit, where the second management request message is used for instructing the NFVO unit to update, query, or delete the descriptors.

In a possible design, the loading method may further include: sending, by the NM unit, a third management request message to the NFVO unit, where the third management request message is used for instructing the NFVO unit to update, query, or delete the image files and the descriptors.

According to still another aspect, an embodiment of the present invention provides an NFVO unit, the NFVO unit can implement functions performed by the NFVO unit in the methods in the foregoing aspects, and the functions may be implemented by using hardware, or may be implemented by hardware executing corresponding software. The hardware or the software includes one or more modules corresponding to the foregoing functions.

In a possible design, a structure of the NFVO unit includes a processor and a communications interface, and the processor is configured to support the NFVO unit in performing the corresponding functions in the foregoing methods. The communications interface is configured to support communication between the NFVO unit and another network element. The NFVO unit may further include a memory, the memory is configured to couple to the processor, and the memory stores necessary program instructions and data of the NFVO unit.

According to still another aspect, an embodiment of the present invention provides an NM unit, the NM can implement functions performed by the NM unit in the method embodiments in the foregoing aspects, and the functions may be implemented by using hardware, or may be implemented by hardware executing corresponding software. The hardware or the software includes one or more modules corresponding to the foregoing functions.

In a possible design, a structure of the NM unit includes a processor and a communications interface, and the processor is configured to support the NM unit in performing the corresponding functions in the foregoing methods. The communications interface is configured to support communication between the NM unit and another network element. The NM unit may further include a memory, the memory is configured to couple to the processor, and the memory stores necessary program instructions and data of the NM unit.

According to still another aspect, an embodiment of the present invention provides a communications system, and the system includes the NFVO unit and the NM unit according to the foregoing aspects.

According to yet another aspect, an embodiment of the present invention provides a computer storage medium, configured to store a computer software instruction used by the foregoing NFVO unit, where the computer software instruction includes a program designed for executing the foregoing aspects.

According to yet another aspect, an embodiment of the present invention provides a computer storage medium, configured to store a computer software instruction used by the foregoing NM unit, where the computer software instruction includes a program designed for executing the foregoing aspects.

Compared with conventional systems, in the solutions provided in the embodiments of the present invention, when needing to load the image files of the some virtualized network function modules in the VNF unit, the NFVO unit may perform an independent loading operation on the image files rather than perform a loading operation on an entire VNF package as in a conventional processing method, thereby preventing image files of other virtualized network function modules in the VNF unit from being reloaded when the image files of only the some virtualized network function modules need to be loaded.

### BRIEF DESCRIPTION OF THE DRAWINGS

To describe the technical solutions in the embodiments of the present invention more clearly, the following briefly describes the accompanying drawings. Apparently, the accompanying drawings in the following description show merely some embodiments of the present invention, and a person of ordinary skill in the art may still derive other drawings from these accompanying drawings without creative efforts.

FIG. 1 is a diagram of an NFV-based network architecture according to an embodiment of the present invention;

FIG. 2 is a schematic diagram of communication of a loading method according to an embodiment of the present invention;

FIG. 3 is a schematic diagram of communication of another loading method according to an embodiment of the present invention;

FIG. 4 is a schematic diagram of communication of still another loading method according to an embodiment of the present invention;

FIG. 5 is a schematic diagram of communication of a management method according to an embodiment of the present invention;

FIG. 6 is a schematic diagram of communication of another management method according to an embodiment of the present invention;

FIG. 7 is a schematic structural diagram of an NFVO according to an embodiment of the present invention;

FIG. 8 is a schematic structural diagram of another NFVO according to an embodiment of the present invention;

FIG. 9 is a schematic structural diagram of an NM according to an embodiment of the present invention; and

FIG. 10 is a schematic structural diagram of another NM according to an embodiment of the present invention.

### DETAILED DESCRIPTION OF ILLUSTRATIVE EMBODIMENTS

The following describes the technical solutions of the embodiments of the present invention with reference to the accompanying drawings in the embodiments of the present invention.

Network architectures and business scenarios described in the embodiments of the present invention aim to more clearly describe the technical solutions in the embodiments of the present invention, but are not intended to limit the technical solutions provided in the embodiments of the present invention. A person of ordinary skill in the art may know that as the network architectures evolve and a new business scenario emerges, the technical solutions provided in the embodiments of the present invention are also applicable to a similar technical problem.

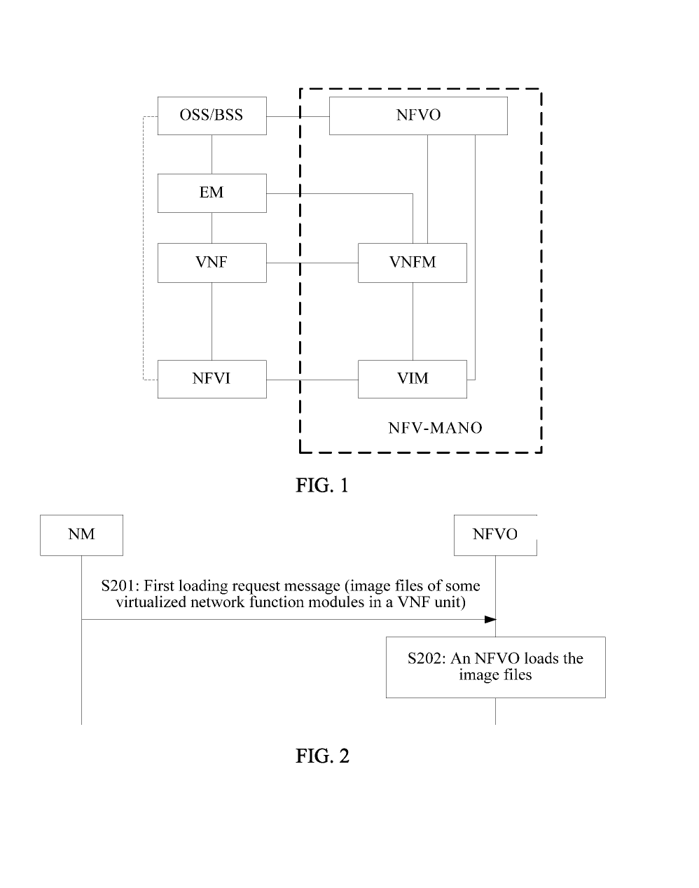

FIG. 1 shows an NFV-based network architecture. As shown in FIG. 1, the network architecture includes a network functions virtualization orchestrator (NFVO) unit, a virtualized network function manager (VNFM) unit, a virtualized infrastructure manager (VIM) unit, an operations support system (OSS) or a business support system (BSS), an element manager (EM) unit, a VNF unit, and a network function virtualization infrastructure (NFVI). The foregoing NFVO unit may also be referred to as a network functions virtualization orchestrator unit, and the foregoing OSS/BSS may also be referred to as a network manager (NM) unit.

For ease of description, the units in FIG. 1 may also be described by using only English acronyms thereof. For example, an NFVO unit may be described as an NFVO, and a VNF unit may be described as a VNF. Other units can be described by analogy, and details are not described again. In the network architecture shown in FIG. 1, a management and orchestration (MANO) domain of an NFV system includes the NFVO, the VNFM and the VIM.

The following briefly describes the foregoing units.

The EM performs function configuration, default management, function use recording, performance statistics, security management, and the like on one VNF or at least two VNFs.

The VNF is a virtualized logical network element such as an SGSN, an MME, a GGSN, an SGW, or a PGW in the telecommunications packet field, and each network element may be independently deployed and is presented as a VNF.

The NFVI provides the VNF with a hardware resource, a virtualized resource, management of the hardware resource and the virtualized resource, and a virtualized operating environment.

The NFVO is responsible for life cycle management of a network service (NS), and can instruct the VIM to orchestrate resources of the NFVI.

The VNFM is responsible for life cycle management of the VNF, and each VNF has an associated VNFM. One VNFM may manage one VNF, or may manage a plurality of VNFs of a same type or even different types.

The VIM is responsible for controlling and managing the resources in the NFVI infrastructure, the resources include a computing resource, a storage resource, a network resource, and the like, and the resources are usually an infrastructure resources of an operator.

It should be noted that any functional unit in the foregoing NFV system may be distributed on one physical device, or may be distributed on a plurality of physical devices, and a plurality of functional units in the NFV system may be respectively distributed on different physical devices, or may be distributed on a same physical device. It may be understood that any functional unit in the NFV system may be a logical function module in a physical device, or may be a logical function module including a plurality of physical devices.

Therefore, in the embodiments of the present invention, one physical device may perform all steps in the method provided in the embodiments of the present invention, or a plurality of physical devices may collaboratively perform all steps in the method provided in the embodiments of the present invention. This is not limited in the present invention.

In the embodiments of the present invention, the NFV system may be applied to a Long Term Evolution (LTE) communications system, may be applied to an LTE-A (Long Term Evolution Advanced) system, a 5th-generation (5G) communications system or another system that may appear in the future, or may be applied to a 3rd-generation (3G) communications system such as a WCDMA system. This is not limited in the present invention.

It should be noted that terms “first”, “second”, and “third” in the embodiments of the present invention are merely used for a purpose of description and used to distinguish different described objects, and shall not be understood as an indication or implication of relative importance or implicit indication of a quantity of indicated technical features.

The following further describes the embodiments of the present invention in detail based on common aspects of the embodiments of the present invention.

Currently, an operation performed on a VNF unit corresponds to an operation performed on an entire VNF package. The VNF package may include a virtualized network function descriptor (VNFD) used for describing a deployment and maintenance template of the VNF unit and image files of software running on the VNF unit, for example, image files of different applications (App) and an image file of virtual machine software or system software that provides the applications with an operating environment. When software is updated, a corresponding image file in the VNF package needs to be replaced with an image file of updated software, and then an entire updated VNF package is reloaded to cover the originally stored VNF package. Consequently, other image files that do not need to be changed are repeatedly loaded. For example, application software has a higher updating frequency than the virtual machine software or the system software, and each time application software needs to be updated, the image file of the virtual machine software or system software is also repeatedly loaded.

In view of this, an embodiment of the present invention provides a loading method, and an NFVO, an NM, and a system that are based on the method. The NFVO receives a first loading request message from the NM, where the first loading request message includes image files of some virtualized network function modules in a VNF unit, and the first loading request message is used for requesting the NFVO unit to load the image files; and the NFVO loads the image files. Optionally, the NFVO may further send a first loading response message to the NM, and the first loading response message is used for notifying that the image files are successfully loaded. It may be understood that the foregoing some virtualized network function modules may be one virtualized network function module or at least two virtualized network function modules. A quantity of the some virtualized network function modules is not limited in this embodiment of the present invention.

According to the solution provided in this embodiment of the present invention, when needing to load the image files of the some virtualized network function modules in the VNF unit, the NFVO may perform an independent loading operation on the image files rather than perform a loading operation on an entire VNF package as in a conventional processing method, thereby preventing image files of other virtualized network function modules in the VNF unit from being reloaded when the image files of only the some virtualized network function modules need to be loaded.

It should be noted that in this embodiment of the present invention, the VNF unit may be pre-divided into a plurality of virtualized network function modules based on an actual requirement. For example, a relatively stable software module in the VNF unit is categorized as a virtualized network function module, each software module having a relatively high updating frequency is categorized as a virtualized network function module. Alternatively, categorization may be performed based on types of software in the VNF unit. One virtualized network function module includes one piece of software or one type of software. The foregoing virtualized network function module may also be referred to as a virtualized network function component (VNFC).

For example, relatively stable software modules such as the virtual machine software and the system software may be categorized as one virtualized network function module. Each piece of application software, for example, each app, that has a relatively high updating frequency may be categorized as a separate virtualized network function module, that is, each virtualized network function module runs one app.

The following describes, with reference to FIG. 2, the solution provided in this embodiment of the present invention. As shown in FIG. 2, a method shown in FIG. 2 may include the following steps.

S201: An NM sends a first loading request message to an NFVO, where the first loading request message includes image files of some virtualized network function modules in a VNF unit, and the first loading request message is used for requesting the NFVO unit to load the image files.

In an example, the foregoing some virtualized network function modules are one virtualized network function module or at least two virtualized network function modules. Therefore, when a single virtualized network function module or at least two virtualized network function modules in the VNF need to be updated, according to the solution of this embodiment of the present invention, only the single virtualized network function module or the at least two virtualized network function modules may be loaded, thereby preventing other virtualized network function modules in the VNF unit from being repeatedly loaded.

In an example, the NM may further send descriptors of the some virtualized network function modules to the NFVO, and the descriptors are used for describing deployment information and maintenance information of the some virtualized network function modules. For example, the descriptors may be included in the foregoing first loading request message, and are sent to the NFVO unit together with the image files. Alternatively, the descriptors may be included in a second loading request message to be sent, and the second loading request message is used for requesting the NFVO unit to load the descriptors.

In an example, the foregoing first loading request message or second loading request message may further include identifiers of the descriptors. Alternatively, the NFVO unit may allocate identifiers of the descriptors to the descriptors after receiving the foregoing descriptors.

S202: The NFVO loads the image files.

In an example, the loading, by the NFVO, the image files may be storing the image files into a pre-designated storage area, so that when subsequently initiating a VNF instantiation operation or initiating a VNF scale-out/scale-in operation, the NFVO can invoke the image file from the storage area. The VNF scale-out/scale-in operation includes a VNF scale-out operation and VNF scale-in operation.

In an example, the NFVO may further load the descriptors. Alternatively, the NFVO may further load the descriptors and the identifiers of the descriptors.

In an example, after successfully loading the image files, the NFVO may further send a first loading response message to the NM, to notify that the NFVO successfully loads the image files.

In an example, the NFVO may further perform updating, query, deletion, or the like on the image files and/or the descriptors. For example, the NFVO may receive a first management request message from the NM, where the first management request message is used for instructing the NFVO unit to update, query, or delete the image files; and then the NFVO updates, queries, or deletes the image files. For another example, the NFVO may receive a second management request message from the NM, where the second management request message is used for instructing the NFVO unit to update, query, or delete the descriptors; and then the NFVO updates, queries, or deletes the descriptors. For another example, the NFVO may receive a third management request message from the NM, where the third management request message is used for instructing the NFVO unit to update, query, or delete the image files and the descriptors; and then the NFVO updates, queries, or deletes the image files and the descriptors.

Further, after the NFVO loads the image files and the descriptors of the some virtualized network function modules in the VNF unit, and when the NFVO performs a VNF instantiation operation or a VNF scale-out/scale-in operation, the NFVO may invoke the image files of the some virtualized network function modules and the descriptors of the some virtualized network function modules from the designated storage area.

In an example, when initiating a VNF instantiation operation, the NFVO may send an instantiation request message to a VNFM, where the instantiation request message carries identifiers of descriptors of all virtualized network function modules in the VNF unit, and the identifiers of the descriptors of all the virtualized network function modules are used for instantiation of the VNF unit.

For example, it is assumed that the VNF is divided into a first virtualized network function module, a second virtualized network function module, and a third virtualized network function module. A descriptor of the first virtualized network function module is a first descriptor, and an image file of the first virtualized network function module is a first image file. A descriptor of the second virtualized network function module is a second descriptor, and an image file of the second virtualized network function module is a second image file. A descriptor of the third virtualized network function module is a third descriptor, and an image file of the third virtualized network function module is a third image file. When the NFVO initiates a VNF instantiation operation, the NFVO sends an instantiation request message to the VNFM. The instantiation request message carries an identifier of the first descriptor. When the NFVO initiates a VNF instantiation operation, the NFVO further sends an identifier of the second descriptor, and an identifier of the third descriptor. After receiving the instantiation request message, the VNFM can invoke the first descriptor and the first image file based on the identifier of the first descriptor, invoke the second descriptor and the second image file based on the identifier of the second descriptor, invoke the third descriptor and the third image file based on the identifier of the third descriptor, and deploy virtual resources and install software based on parameters in the descriptors, to complete instantiation of the VNF unit.

In an example, when initiating a VNF scale-out/scale-in operation, the NFVO sends a scale-out request message or a scale-in request message to the VNFM, where the scale-out request message or the scale-in request message includes the identifiers of the descriptors of the some virtualized network function modules, and the identifiers of the descriptors of the some virtualized network function modules are used for scale-out or scale-in of the some virtualized network function modules.

For example, the scale-out request message includes the identifier of the first descriptor, and the scale-out request message is used for instructing the VNFM to perform a scale-out operation on the VNF unit. After receiving the scale-out request message, the VNFM may invoke the first descriptor and the first image file based on the identifier of the first descriptor, to deploy the first virtualized network function module, thereby completing the scale-out operation performed on the VNF unit.

It may be understood that in a scale-out/scale-in process of the VNF unit, the NFVO unit may redeploy some designated virtualized network function modules in the VNF unit, and does not need to redeploy the entire VNF unit.

According to the solution provided in this embodiment of the present invention, when needing to load the image files of the some virtualized network function modules in the VNF unit, the NFVO may perform an independent loading operation on the image files rather than perform a loading operation on an entire VNF package as in a conventional processing method, thereby preventing image files of other virtualized network function modules in the VNF unit from being reloaded when the image files of only the some virtualized network function modules in the VNF unit need to be loaded.

It may be learned from the foregoing descriptions that optionally, in this embodiment of the present invention, some virtualized network function modules in the VNF unit may have corresponding descriptors, the descriptors are used for describing deployment information and maintenance information of the some virtualized network function modules. For example, the descriptors may include parameter information of virtual resources such as a connectivity resource, a virtual interface, a storage resource, and a computing resource that are required for deploying the some virtualized network function modules. The NFVO can perform instantiation or scale-out or scale-in on the some virtualized network function modules based on the descriptors. It may be understood that the NFVO needs to first load the descriptors before performing instantiation or scale-out or scale-in on the some virtualized network function modules by using the descriptors.

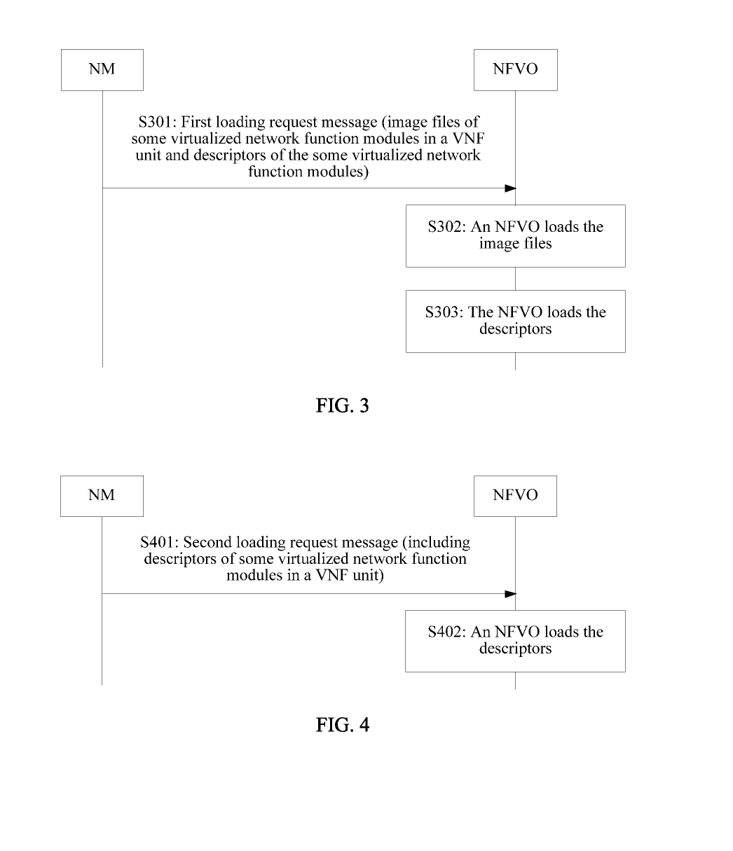

For the descriptors of the some virtualized network function modules, the NFVO may receive the foregoing image files and the descriptors together, or may separately receive the foregoing image files and the descriptors. The following separately describes the two cases with reference to FIG. 3 and FIG. 4.

Based on the method shown in FIG. 2, FIG. 3 shows another loading method according to an embodiment of the present invention. The NFVO may receive the image files and the descriptors of the some virtualized network function modules together. In the method shown in FIG. 3, for content same as or similar to that in the method shown in FIG. 2, refer to the detailed descriptions in FIG. 2. Details are not described herein again. As shown in FIG. 3, the method may include the following steps:

S301: The NM sends a first loading request message to the NFVO, where the first loading request message includes the image files of the some virtualized network function modules in the VNF unit and the descriptors of the some virtualized network function modules.

S302: The NFVO loads the image files.

S303: The NFVO loads the descriptors.

Optionally, S302 and S303 may also be combined into one step. For example, S302 and S303 may be replaced with step S304. Step S304 is that the NFVO loads the image files and the descriptors.

The loading, by the NFVO, the image files and the descriptors may be storing the image files and the descriptors into a pre-designated storage area, so that when subsequently using the image files and the descriptors, the NFVO can invoke the image files and the descriptors from the storage area.

In this embodiment of the present invention, a corresponding package may be set for some virtualized network function modules in the VNF unit, and the first loading request message includes image files and descriptors of the some virtualized network function modules, in other words, it may be understood that the first loading request message includes the package corresponding to the some virtualized network function modules. After receiving the first loading request message, the NFVO may load the package corresponding to the some virtualized network function modules.

When needing to load the image files and/or the descriptors of the some virtualized network function modules in the VNF unit, the NFVO may perform an independent loading operation on the package corresponding to the some virtualized network function modules rather than perform a loading operation on an entire VNF package as in a conventional processing method, thereby preventing image files or descriptors of other virtualized network function modules in the VNF unit from being reloaded when the image files and/or the descriptors of only the some virtualized network function modules need to be loaded.

Further, the first loading request message may further include identifiers of the descriptors, and the identifiers of the descriptors may be allocated to the descriptors by the NM, or may be preconfigured.

The identifiers of the descriptors may serve as parameters of the descriptors to be set in the descriptors, or may be independent of the descriptors. Therefore, after receiving the first loading request message, the NFVO may load the identifiers of the descriptors and the descriptors. For example, a correspondence between the identifiers of the descriptors and the descriptors may be stored into a designated storage area, so that when performing a VNF unit instantiation operation or initiating a VNF unit scale-out/scale-in operation, the NFVO can invoke the descriptors corresponding to the identifiers of the descriptors from the storage area based on the identifiers of the descriptors.

Optionally, in this embodiment of the present invention, the identifiers of the descriptors may alternatively be allocated by the NFVO. In an example, after receiving the first loading request message, the NFVO may first allocate the identifiers of the descriptors to the descriptors, and then load the descriptors and the identifiers of the descriptors.

It may be understood that after successfully loading the image files and the descriptors, the NFVO may send a first loading response message to the NM, to notify that the image files and the descriptors are successfully loaded. Optionally, the NFVO may add, to the first loading response message, the identifiers allocated to the descriptors by the NFVO, to send the identifiers to the NM, or the NFVO may add the identifiers of the descriptors to another message to send the identifiers to the NM, to enable the NM to learn of the identifiers of the descriptors, so that the NM can initiate a VNF unit instantiation operation or initiate a VNF unit scale-out/scale-in operation by using the identifiers of the descriptors.

FIG. 3 shows a case in which the NFVO receives the image files and the descriptors together. The following describes, with reference to FIG. 4, a case in which the image files and the descriptors are separately received. It should be noted that a method shown in FIG. 4 may be implemented after the method shown in FIG. 2 is performed. For the content in FIG. 2, refer to the foregoing descriptions, and details are not described herein again. As shown in FIG. 4, the method may include the following steps:

S401: The NM sends a second loading request message to the NFVO, where the second loading request message includes descriptors of the some virtualized network function modules in the VNF unit.

S402: The NFVO loads the descriptors.

According to the method, when a deployment manner of the some virtualized network function modules in the VNF unit needs to be updated, the NFVO may perform an independent loading operation on the descriptors of the some virtualized network function modules rather than perform a loading operation on a VNF package as in a conventional processing method, thereby preventing a deployment manner of other virtualized network function modules in the VNF unit from being repeatedly loaded when the deployment manner of only the some virtualized network function modules in the VNF unit needs to be updated.

Optionally, when methods shown in FIG. 2 and FIG. 4 are performed, step S202 may be combined into step S402 for performing. That is, after receiving the first loading request message and the second loading request message, the NFVO loads the image files and the descriptors together.

Further, the second loading request message further includes identifiers of the descriptors, and the identifiers of the descriptors may be allocated to the descriptors by the NM, or may be preconfigured. After receiving the second loading request message, the NFVO may load the identifiers of the descriptors and the descriptors.

Optionally, in this embodiment of the present invention, the identifiers of the descriptors may alternatively be allocated by the NFVO. In an example, after receiving the second loading request message, the NFVO may first allocate the identifiers of the descriptors to the descriptors, and then load the descriptors and the identifiers of the descriptors.

After successfully loading the image files and the descriptors, the NFVO may send a first loading response message to the NM, to notify that the image files and the descriptors are successfully loaded. If the NFVO further allocates the identifiers to the descriptors, the NFVO may add the identifiers of the descriptors to the first loading response message or another message to send the identifiers to the NM, to enable the NM to learn of the identifiers of the descriptors, so that the NM can initiate a VNF unit instantiation operation or initiate a VNF unit scale-out/scale-in operation by using the identifiers of the descriptors.

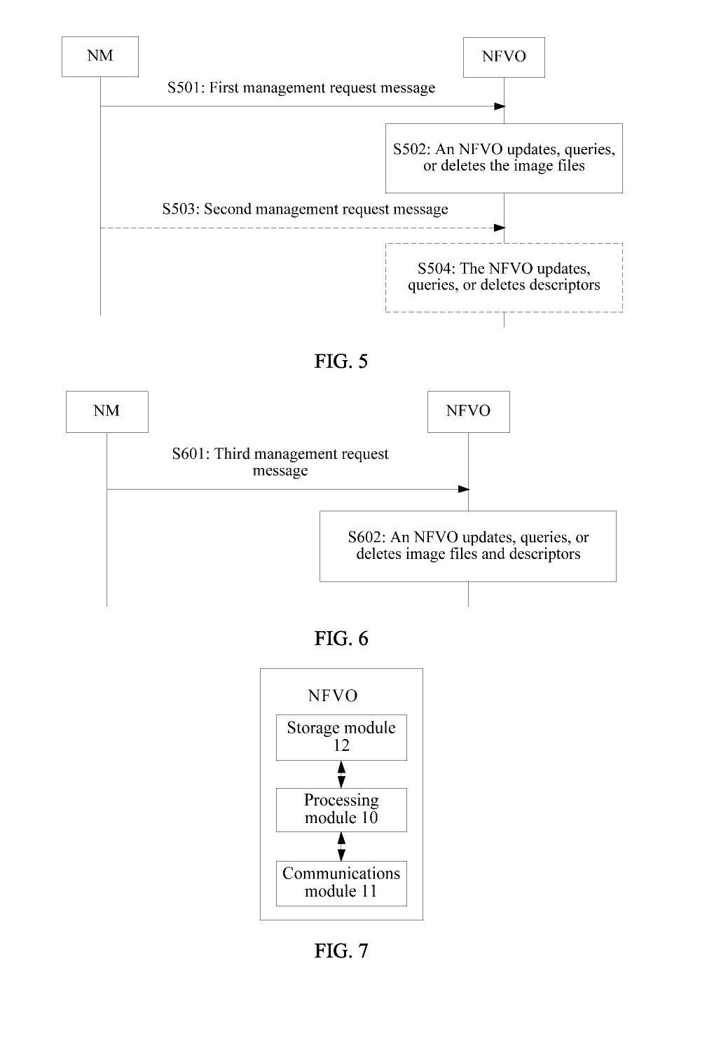

In this embodiment of the present invention, after the NFVO loads the image files and/or the descriptors, the NFVO may further perform a management operation such as updating, querying, or deletion on the image files and/or the descriptors. For example, after the method shown in at least one of FIG. 2 to FIG. 4 is performed, a method shown in FIG. 5 or FIG. 6 may further be performed.

FIG. 5 shows a management method. The method shown in FIG. 5 may include the following steps.

S501: The NFVO receives a first management request message from the NM, where the first management request message is used for instructing the NFVO unit to update, query, or delete the image files.

S502: The NFVO updates, queries, or deletes the image files.

Based on the method, when software in the some virtualized network function modules in the VNF unit needs to be updated or deleted, the NM may instruct, by using the first management request message, the NFVO unit to perform an independent management operation on the image files of the some virtualized network function modules, to avoid reloading of image files of other virtualized network function modules in the VNF unit due to updating of an entire VNF package caused by updating or deletion of the image files of the some virtualized network function modules in a common processing method, thereby greatly reducing a workload of network maintenance.

Through S501 and S502, after the image files of the some virtualized network function modules in the VNF unit are loaded, the NFVO may perform an independent management operation on the image files.

Optionally, after the descriptors of the some virtualized network function modules are loaded, the NFVO may alternatively perform an independent management operation on the descriptors. As shown in FIG. 5, the method may further include the following steps:

S503: The NFVO receives a second management request message from the NM, where the second management request message is used for instructing the NFVO unit to update, query, or delete the descriptors.

S504: The NFVO updates, queries, or deletes the descriptors.

When the some virtualized network function modules need to be redeployed or deleted, an NFVO unit can perform an independent management operation on the descriptors, to avoid a problem of redeployment of the entire VNF unit caused by updating of a VNFD of the VNF unit in which the some virtualized network function modules are located because the some virtualized network function modules need to be redeployed or deleted in a common processing method, thereby greatly reducing a workload and a risk of network maintenance.

It should be noted that the method shown in FIG. 5 may include only S501 and S502, may include only S503 and S504, or may include S501 to S504.

FIG. 6 shows another management method. The method shown in FIG. 6 may include the following steps.

S601: The NFVO receives a third management request message from the NM, where the third management request message is used for instructing the NFVO unit to update, query, or delete the image files and the descriptors.

S602: The NFVO updates, queries, or deletes the image files and the descriptors.

Based on the method, when a related management operation needs to be performed on the some virtualized network function modules in the VNF unit, for example, application software needs to be updated, a deployment manner needs to be updated, or the some virtualized network function modules need to be deleted, the NM may instruct, by using the third management request message, the NFVO unit to perform an independent management operation on a package corresponding to the some virtualized network function modules, to avoid a related management operation performed on the entire VNF unit caused by a management operation performed on an entire VNF package because the related management operation needs to be performed on the some virtualized network function modules in a common processing method, thereby greatly reducing a workload and a risk of network maintenance.

The foregoing mainly describes the solutions provided in the embodiments of the present invention from the perspective of interaction between network elements. It can be understood that, to implement the foregoing functions, the NFVO or NM includes corresponding hardware structures and/or software modules for performing the functions. A person skilled in the art should be easily aware that, the units and algorithm steps in the examples described with reference to the embodiments disclosed in this specification may be implemented by hardware or a combination of hardware and computer software in the present invention. Whether a function is performed by hardware or computer software driving hardware depends on particular applications and design constraint conditions of the technical solutions. A person skilled in the art may use different methods to implement the described functions for each particular application, but it should not be considered that the implementation goes beyond the scope of the present invention.

In the embodiments of the present invention, function modules in the NFVO or NM may be divided according to the foregoing method examples. For example, function modules may be divided corresponding to the functions, or two or more functions may be integrated into one processing module. The integrated module may be implemented in a form of hardware, or may be implemented in a form of a functional module of software. It should be noted that the module division in the embodiments of the present invention is an example, and is merely logical function division. There may be another division manner in an actual implementation.

When an integrated unit is used, FIG. 7 is a possible schematic structural diagram of an NFVO in the foregoing embodiments. The NFVO includes a processing module 10 and a communications module 11. The processing module 10 is configured to control and manage an action of the NFVO. For example, the processing module 10 is configured to support the NFVO in performing the process S202 in FIG. 2, the processes S302 and S303 in FIG. 3, the process S402 in FIG. 4, the processes S502 and S504 in FIG. 5, and the process S602 in FIG. 6, and/or other processes used for technologies described in this specification. The communications module 11 is configured to support communication between the NFVO and another network entity, for example, communication between the NFVO and a function module or a network entity that is shown in FIG. 1. The NFVO may further include a storage module 12, configured to store program code and data of the NFVO.

The processing module 10 may be a processor or a controller, and for example, may be a central processing unit (CPU), a general purpose processor, a digital signal processor (DSP), an application-specific integrated circuit (ASIC), a field programmable gate array (FPGA) or another programmable logic device, a transistor logic device, a hardware component, or any combination thereof. The processing module 10 may implement or execute various examples of logical blocks, modules, and circuits that are described with reference to the content disclosed in the present invention. The processor may also be a combination implementing a computing function, for example, a combination of one microprocessor or at least two microprocessors or a combination of a DSP and a microprocessor. The communications module 11 may be a transceiver, a transceiver circuit, a communications interface, or the like. The storage module 12 may be a memory.

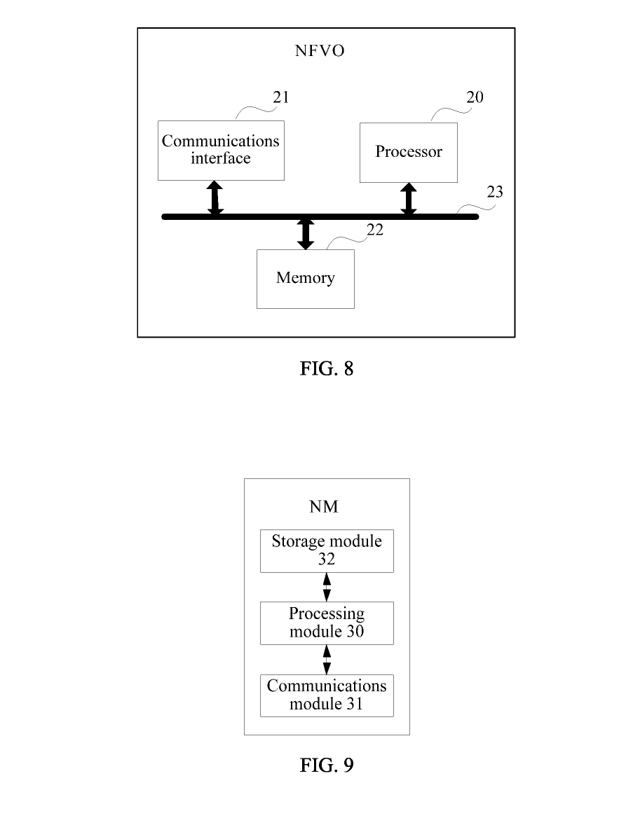

When the processing module 10 is a processor, the communications module 11 is a communications interface, and the storage module 12 is a memory, the NFVO in this embodiment of the present invention may be an NFVO shown in FIG. 8.

Referring to FIG. 8, the NFVO includes a processor 20, a communications interface 21, a memory 22, and a bus 23. The communications interface 21, the processor 20, and the memory 22 are connected to each other by using the bus 23. The bus 23 may be a peripheral component interconnect (PCI) bus, an extended industry standard architecture (EISA) bus, or the like. The bus may be categorized as an address bus, a data bus, a control bus, or the like. For ease of indication, the bus is indicated by using only one bold line in FIG. 8. However, it does not indicate that there is only one bus or only one type of bus.

When an integrated unit is used, FIG. 9 is a possible schematic structural diagram of an NM in the foregoing embodiments. The NM includes a processing module 30 and a communications module 31. The processing module 30 is configured to control and manage an action of the NM. For example, the processing module 30 is configured to support the NM in performing the process S201 in FIG. 2, the process S301 in FIG. 3, the process S401 in FIG. 4, the processes S501 and S503 in FIG. 5, and the process S601 in FIG. 6, and/or other processes used for technologies described in this specification. The communications module 31 is configured to support communication between the NM and another network entity, for example, communication between the NM and a function module or a network entity that is shown in FIG. 1. The NM may further include a storage module 32, configured to store program code and data of the NM.

The processing module 30 may be a processor or a controller, and for example, may be a CPU, a general purpose processor, a DSP, an ASIC, an FPGA or another programmable logic device, a transistor logic device, a hardware component, or any combination thereof. The processing module 30 may implement or execute various examples of logical blocks, modules, and circuits that are described with reference to the content disclosed in the present invention. The processor may also be a combination implementing a computing function, for example, a combination of one or more microprocessors, or a combination of a DSP and a microprocessor. The communications module 31 may be a transceiver, a transceiver circuit, a communications interface, or the like. The storage module 32 may be a memory.

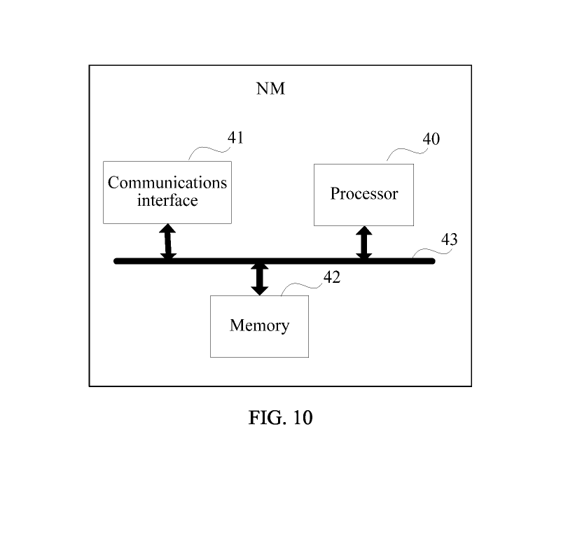

When the processing module 30 is a processor, the communications module 31 is a communications interface, and the storage module 32 is a memory, the NM in this embodiment of the present invention may be an NM shown in FIG. 10.

Referring to FIG. 10, the NM includes a processor 40, a communications interface 41, a memory 42, and a bus 43. The communications interface 41, the processor 40, and the memory 42 are connected to each other by using the bus 43. The bus 43 may be a PCI bus, an EISA bus, or the like. The bus may be categorized as an address bus, a data bus, a control bus, or the like. For ease of indication, the bus is indicated by using only one bold line in FIG. 10. However, it does not indicate that there is only one bus or only one type of bus.

The methods or algorithm steps described with reference to the content disclosed in the present invention may be implemented in a hardware manner, or may be implemented in a manner of executing a software instruction by a processor. The software instruction may include a corresponding software module. The software module may be stored in a random access memory (RAM), a flash memory, a read-only memory (ROM), an erasable programmable read-only memory (EPROM), an electrically erasable programmable read-only memory (EEPROM), a register, a hard disk, a removable hard disk, a compact disc read-only memory (CD-ROM), or a storage medium in any other forms well-known in the art. A storage medium used as an example is coupled to the processor, so that the processor can read information from the storage medium, and can write information into the storage medium. Certainly, the storage medium may be a part of the processor. The processor and the storage medium may be located in an ASIC. In addition, the ASIC may be located in an NFVO or NM. Certainly, the processor and the storage medium may alternatively exist in the NFVO or NM as discrete assemblies.

A person skilled in the art should be aware that in one or more of the foregoing examples, the functions described in the present invention may be implemented by using hardware, software, firmware, or any combination thereof. When this application is implemented by software, these functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or special-purpose computer.

The objectives, technical solutions, and beneficial effects of the present invention are further described in detail in the foregoing specific implementations. It should be understood that the foregoing descriptions are merely specific implementations of the present invention, but are not intended to limit the protection scope of the present invention. Any modification, equivalent replacement, improvement, or the like made based on the technical solutions of the present invention shall fall within the protection scope of the present invention.

1.-20. (canceled)

21. A method, comprising:
receiving, by a network functions virtualization orchestrator (NFVO) device, a first loading request message from a network manager (NM) device, wherein the first loading request message comprises image files of a first plurality of virtualized network function modules in a virtualized network function (VNF) device, and the first loading request message requests the NFVO device to load the image files of the first plurality of virtualized network function modules; and
loading, by the NFVO device, the image files of the first plurality of virtualized network function modules without loading an image file of a second virtualized network module in the VNF device, wherein the image file of the second virtualized network module is not comprised in the first loading request message.

22. The method according to claim 21, wherein the method further comprises:
receiving, by the NFVO device, a second loading request message from the NM device, wherein the second loading request message comprises descriptors of the first plurality of virtualized network function modules, the descriptors of the first plurality of virtualized network function modules describe deployment information and maintenance information of the first plurality of virtualized network function modules, and the second loading request message requests the NFVO device to load the descriptors of the first plurality of virtualized network function modules; and
loading, by the NFVO device, the descriptors of the first plurality of virtualized network function modules.

23. The method according to claim 22, wherein the first loading request message or the second loading request message further comprises identifiers of the descriptors of the first plurality of virtualized network function modules, and loading, by the NFVO device, the descriptors of the first plurality of virtualized network function modules comprises:
loading, by the NFVO device, the descriptors of the first plurality of virtualized network function modules and the identifiers of the descriptors of the first plurality of virtualized network function modules.

24. The method according to claim 21, wherein the first loading request message further comprises descriptors of the first plurality of virtualized network function modules, the descriptors describe deployment information and maintenance information of the first plurality of virtualized network function modules, and the method further comprises:
loading, by the NFVO device, the descriptors of the first plurality of virtualized network function modules.

25. The method according to claim 24, wherein the method further comprises:
allocating, by the NFVO device, identifiers of the descriptors of the first plurality of virtualized network function modules to the descriptors of the first plurality of virtualized network function modules; and
loading, by the NFVO device, the descriptors of the first plurality of virtualized network function modules comprises:
loading, by the NFVO device, the descriptors of the first plurality of virtualized network function modules and the identifiers of the descriptors of the first plurality of virtualized network function modules.

26. The method according to claim 24, wherein the method further comprises:
receiving, by the NFVO device, a first management request message from the NM device, wherein the first management request message instructs the NFVO device to update, query, or delete the image files of the first plurality of virtualized network function modules; and
updating, querying, or deleting, by the NFVO device, the image files of the first plurality of virtualized network function modules.

27. The method according to claim 24, wherein the method further comprises:
receiving, by the NFVO device, a second management request message from the NM device, wherein the second management request message instructs the NFVO device to update, query, or delete the descriptors of the first plurality of virtualized network function modules; and
updating, querying, or deleting, by the NFVO device, the descriptors of the first plurality of virtualized network function modules.

28. The method according to claim 24, wherein the method further comprises:
receiving, by the NFVO device, a third management request message from the NM device, wherein the third management request message instructs the NFVO device to update, query, or delete the image files of the first plurality of virtualized network function modules and the descriptors of the first plurality of virtualized network function modules; and
updating, querying, or deleting, by the NFVO device, the image files of the first plurality of virtualized network function modules and the descriptors of the first plurality of virtualized network function modules.

29. The method according to claim 24, wherein the method further comprises:
sending, by the NFVO device, an instantiation request message to a virtualized network function manager (VNFM) device, wherein the instantiation request message comprises identifiers of descriptors of all virtualized network function modules in the VNF device, and the identifiers of the descriptors of all the virtualized network function modules are used for instantiation of the VNF device.

30. The method according to claim 29, wherein the method further comprises:
sending, by the NFVO device, a scale-out request message or a scale-in request message to a VNFM device, wherein the scale-out request message or the scale-in request message comprises the identifiers of the descriptors of the first plurality of virtualized network function modules, and the identifiers of the descriptors of the first plurality of virtualized network function modules are used for scale-out or scale-in of the first plurality of virtualized network function modules.

31. A device, comprising:
memory, configured to store computer executable program code; and
a processor, coupled to the memory, wherein
the program code comprises instructions, and when the processor executes the instructions, the instructions enables the device to perform the following operations:
receiving a first loading request message from a network manager (NM) device, wherein the first loading request message comprises image files of a first plurality of virtualized network function modules in a virtualized network function (VNF) device, and the first loading request message requests the device to load the image files of the first plurality of virtualized network function modules; and
loading the image files of the first plurality of virtualized network function modules without loading an image file of a second virtualized network module in the VNF device, wherein the image file of the second virtualized network module is not comprised in the first loading request message.

32. The device according to claim 31, the operations further comprise:
receiving a second loading request message from the NM device, wherein the second loading request message comprises descriptors of the first plurality of virtualized network function modules, the descriptors of the first plurality of virtualized network function modules describe deployment information and maintenance information of the first plurality of virtualized network function modules, and the second loading request message requests the NFVO device to load the descriptors of the first plurality of virtualized network function modules; and
loading the descriptors of the first plurality of virtualized network function modules.

33. The device according to claim 32, wherein the first loading request message or the second loading request message further comprises identifiers of the descriptors of the first plurality of virtualized network function modules, and the operations further comprise:
loading the descriptors of the first plurality of virtualized network function modules and the identifiers of the descriptors of the first plurality of virtualized network function modules.

34. The device according to claim 31, wherein the first loading request message further comprises descriptors of the first plurality of virtualized network function modules, the descriptors of the first plurality of virtualized network function modules describe deployment information and maintenance information of the first plurality of virtualized network function modules; the operations further comprise:
loading the descriptors of the first plurality of virtualized network function modules.

35. The device according to claim 34, wherein the operations further comprise:
allocating identifiers of the descriptors of the first plurality of virtualized network function modules to the descriptors of the first plurality of virtualized network function modules; and
loading the descriptors of the first plurality of virtualized network function modules and the identifiers of the descriptors of the first plurality of virtualized network function modules.

36. The device according to claim 34, wherein the operations further comprising:
receiving a first management request message from the NM device, wherein the first management request message instructs the device to update, query, or delete the image files; and
updating, querying, or deleting the image files.

37. The device according to claim 34, wherein the operations further comprise:
receiving a second management request message from the NM device, wherein the second management request message instructs the device to update, query, or delete the descriptors of the first plurality of virtualized network function modules; and
updating, querying, or deleting the descriptors of the first plurality of virtualized network function modules.

38. The device according to claim 34, wherein the operations further comprise:
receiving a third management request message from the NM device, wherein the third management request message instructs the device to update, query, or delete the image files of the first plurality of virtualized network function modules and the descriptors of the first plurality of virtualized network function modules; and
updating, querying, or deleting the image files of the first plurality of virtualized network function modules and the descriptors of the first plurality of virtualized network function modules.

39. The device according to claim 34, wherein the operations further comprise:
sending an instantiation request message to a virtualized network function manager (VNFM) device, wherein the instantiation request message comprises identifiers of descriptors of all virtualized network function modules in the VNF device, and the identifiers of the descriptors of all the virtualized network function modules are used for instantiation of the VNF device.

40. A system, comprising:
a network manager (NM) device; and
a network functions virtualization orchestrator (NFVO) device comprising:
memory, configured to store computer executable program code; and
a processor, coupled to the memory, wherein
the program code comprises instructions, and when the processor executes the instructions, the instructions enables the device to perform the following operations:
receiving a first loading request message from the NM device, wherein the first loading request message comprises image files of a first plurality of virtualized network function modules in a virtualized network function (VNF) device, and the first loading request message requests the NFVO device to load the image files of the first plurality of virtualized network function modules; and
loading the image files of the first plurality of virtualized network function modules without loading an image file of a second virtualized network module in the VNF device, wherein the image file of the second virtualized network module is not comprised in the first loading request message.
